(19) United States
(12) Patent Application Publication
(10) Pub. No.: US 2025/0141891 A1
(43) Pub. Date: May 1, 2025

(54) SYSTEMS AND METHODS FOR EVALUATING ENTITIES COMMUNICATING OVER A NETWORK

(71) Applicant: Edgio, Inc., Phoenix, AZ (US)

(72) Inventors: Faraz Waseem, Fremont, CA (US); Ashutosh Malgaonkar, Sunnyvale, CA (US); Michael Clayborne Moore, Addison, TX (US); Ross Schlegel, Mableton, GA (US); Vincent Antonio Robbins, Los Angeles, CA (US)

(73) Assignee: Edgio, Inc., Phoenix, AZ (US)

(21) Appl. No.: 18/933,179

(22) Filed: Oct. 31, 2024

Related U.S. Application Data
(60) Provisional application No. 63/546,690, filed on Oct. 31, 2023.

(51) Int. Cl. H04L 9/40

(52) U.S. Cl. CPC H04L 63/1416

(57) ABSTRACT

Described herein are various examples of techniques for evaluation of entities communicating over a network. An example method may include receiving a set of network traffic data and a potential bot candidate associated with the set of network traffic data. The example method may also include adjusting a bot risk assessment associated with the potential bot candidate by analyzing a subset of the set of network traffic data corresponding to the potential bot candidate via an expert machine learning model trained to detect attack vectors based on network traffic data associated with potential bot candidates. The example method may further include outputting the bot risk assessment associated with the potential bot candidate. Various other systems, methods, and computer-readable media are also disclosed.

### CROSS REFERENCE TO RELATED APPLICATION

This application claims the benefit under 35 U.S.C. § 119(e) of U.S. Provisional Patent Application No. 63/546,690, filed Oct. 31, 2023, the entire contents of which are incorporated herein by reference.

### BACKGROUND

Content delivery networks (CDNs) allow for the widespread distribution of content, including images, videos, and large files to users. A typical CDN includes a plurality of distributed servers in different locations; each server hosting some or substantially all of the same content as any other server in the network. This architecture allows for low latency-high performance delivery of content by bringing the source of the content closer to the user.

### SUMMARY

This disclosure is generally directed to systems and methods for evaluating entities communicating over a network. Some embodiments may relate to a method that may include: receiving a set of network traffic data and data representative of a potential bot candidate associated with the set of network traffic data; adjusting a bot risk assessment associated with the potential bot candidate by analyzing a subset of the set of network traffic data corresponding to the potential bot candidate via an expert machine learning model trained to detect attack vectors based on network traffic data associated with potential bot candidates; and outputting the bot risk assessment associated with the potential bot candidate.

In some embodiments, the expert machine learning model may include a self-supervised generative machine learning model.

In some embodiments, the self-supervised generative machine learning model may use a session included in the set of network traffic data as a context window for predicting attack vectors.

In some embodiments, the self-supervised generative machine learning model may use masked tokens generated from the set of network traffic data to predict attack vectors.

In some embodiments, the method may further include discovering, by processing the set of network traffic data via a discoverer machine learning model trained to discover potential bot candidates from aggregate network traffic data, the potential bot candidate.

In some embodiments, the method may further include training the discoverer machine learning model by: receiving a labeled dataset including aggregate network traffic data and at least one bot activity indicator; extracting fingerprinting features and behavior features from the labeled dataset; training a discoverer machine learning model using the fingerprinting features and behavior features to identify potential bot candidates based at least in part on the aggregate network traffic data; and storing the discoverer machine learning model in a computer-readable storage medium.

In some embodiments, the method may further include adjusting the discoverer machine learning model based on an output from the expert machine learning model.

In some embodiments, a parameter amount of the discoverer machine learning model may include an amount value fewer than a parameter amount of the expert machine learning model.

In some embodiments, the parameter amount of the discoverer machine learning model is within a lightweight model parameter amount threshold.

In some embodiments, the lightweight model parameter amount threshold may include at least one of: up to 1,000,000 parameters; or between 1,000,000 parameters and 1,000,000,000 parameters.

In some embodiments, the parameter amount of the expert machine learning model may exceed a heavyweight model parameter amount threshold.

In some embodiments, the heavyweight model parameter amount threshold may include at least 1,000,000,000 parameters.

In some embodiments, a computing resource requirement of the expert machine learning model may exceed a threshold computing resource requirement.

In some embodiments, a computing resource requirement of the discoverer machine learning model is within the threshold computing resource requirement.

In some embodiments, discovering the potential bot candidate may include: identifying an entity that has transmitted message information included in the set of network traffic data; generating signature information associated with the entity based at least in part on the message information included in the set of network traffic data associated with the entity; and designating, based at least on the signature information and the message information included in the set of network traffic data associated with the entity, the entity as the potential bot candidate.

In some embodiments, the set of network traffic data may include at least one of: data traffic between at least one source entity and at least one target entity; a volume of the data traffic between at least one source entity and at least one target entity; a set of unique URLs traversed by an entity; or geographic location information associated with at least one host.

In some embodiments, the method may further include training the expert machine learning model by: receiving a labeled dataset including network traffic data associated with identified potential bot candidates; detecting, by analyzing the labeled dataset, a plurality of potential attack vectors; training a expert machine learning model using the network traffic data to further analyze and adjust bot risk assessments for the identified potential bot candidates based on the plurality of potential attack vectors; and storing the expert machine learning model in a computer-readable storage medium.

Some embodiments may relate to a system including: at least one processor; and at least one storage medium having encoded thereon executable instructions that, when executed by the at least one processor, cause the at least one processor to carry out a method including: receiving a set of network traffic data and data representative of a potential bot candidate associated with the set of network traffic data; adjusting a bot risk assessment associated with the potential bot candidate by analyzing a subset of the set of network traffic data corresponding to the potential bot candidate via an expert machine learning model trained to detect attack vectors based on network traffic data associated with potential bot candidates; and outputting the bot risk assessment associated with the potential bot candidate.

In some embodiments, the method may further include discovering, by processing the set of network traffic data via a discoverer machine learning model trained to discover potential bot candidates from aggregate network traffic data, the potential bot candidate.

Some embodiments may relate to at least one computer-readable storage medium having encoded thereon executable instructions that, when executed by at least one processor, cause the at least one processor to carry out a method including: receiving a set of network traffic data and data representative of a potential bot candidate associated with the set of network traffic data; adjusting a bot risk assessment associated with the potential bot candidate by analyzing a subset of the set of network traffic data corresponding to the potential bot candidate via an expert machine learning model trained to detect attack vectors based on network traffic data associated with potential bot candidates; and outputting the bot risk assessment associated with the potential bot candidate.

### BRIEF DESCRIPTION OF THE DRAWINGS

The accompanying drawings illustrate a number of example embodiments and are a part of the specification. Together with the following description, these drawings demonstrate and explain various principles of the instant disclosure.

FIG. 1 illustrates a system within which some embodiments may operate.

FIG. 2 is a block diagram of an example system for evaluating entities communicating over a network.

FIG. 2 is a block diagram of an example system that implements a system for evaluating entities communicating over a network.

FIG. 3 is a flow diagram of an example method for evaluating entities communicating over a network.

FIG. 4 is a flow diagram that illustrates a basic operational flow for evaluating entities communicating over a network in accordance with some embodiments described herein.

FIG. 5 is a block diagram that illustrates an implementation of an example system for evaluating entities communicating over a network in accordance with some embodiments of the present invention.

FIG. 6 includes a block diagram that illustrates a possible architecture for a supervised learning model in accordance with some embodiments disclosed herein.

FIG. 7 includes a block diagram that illustrates a possible architecture for a volumetric anomalies model in accordance with some embodiments disclosed herein.

FIG. 8 includes a block diagram that provides a visual representation of a data flow and processing steps involved in this second-stage volumetric anomaly detection.

FIG. 9 includes a block diagram that provides a visual representation of a process for making inferences using a vector space model in accordance with some embodiments disclosed herein.

FIG. 10 includes a block diagram that provides a visual representation of a process flow related to the utilization and fine-tuning of a generative model using Web Application Firewall logs.

FIG. 11 includes a block diagram that provides a visual representation of a process flow that leverages a fine-tuned generative model to classify attack vectors from access logs.

FIG. 12 is a flow diagram of an example method for evaluating entities communicating over a network.

FIG. 13 is a flow diagram of an example method for training an expert machine learning model in accordance with some embodiments disclosed herein.

FIG. 14 is a flow diagram of an example method for training a discoverer machine learning model in accordance with some embodiments disclosed herein.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the instant disclosure covers all modifications, equivalents, and alternatives falling within the scope of the appended claims.

### DETAILED DESCRIPTION OF EXAMPLE EMBODIMENTS

Described herein are embodiments of techniques for evaluating entities communicating over a network, which may in some cases include server-side techniques for evaluating network traffic observed by one or more servers in the network. In some embodiments, server-side identification may include signature analysis, including collecting information regarding the entity from communications received at the server and using such information to determine a signature of the entity. Such a server may be an intermediary server that may perform caching functionality and serve to clients content stored by one or more other servers on the network. In some embodiments, server-side identification can additionally or alternatively include behavior analysis, including current behaviors and historical behaviors gathered in part from network traffic transmitted by the entity, such as traffic between the entity and other devices on the network, such as the server doing the behavior analysis, other servers, or other devices.

At least one example embodiment may receive a set of network traffic data and a potential bot candidate associated with the set of network traffic data. In some examples, network traffic data may refer to information and/or metadata transmitted over a computer network. This data may encompass various forms of digital communications, including but not limited to packet headers and payloads, protocol data units, source and destination IP addresses, port numbers, timestamps, data volume, and/or patterns of data flow. Network traffic data may also include aggregated data derived from these transmissions, such as session information, connection logs, and behavioral analytics. This data may serve as a foundation for analyzing network activity, identifying anomalies, and assessing potential security threats. A potential bot candidate may refer to an entity or set of activities within a network that exhibits characteristics or patterns typically associated with automated processes or non-human behavior. This can include, but is not limited to, unusual traffic patterns, repetitive or scripted actions, deviations from normal user behavior, and/or other indicators suggestive of bot-like activity. Such candidates are identified through analysis of network traffic data and may be subject to further investigation to ascertain their nature and intent. The term is inclusive of any network entity or activity that may warrant evaluation for potential automated behavior.

Bot risk assessment may refer to a process and/or outcome of evaluating the likelihood or potential impact of automated or bot-like activities within a network. This assessment may involve analyzing various indicators, such as traffic patterns, behavioral anomalies, and/or historical data, to determine the risk associated with a potential bot candidate. The assessment may produce a risk score, classification, or other evaluative measure that can inform security responses or further investigations. Hence, in some examples, a bot risk assessment may guide decisions on mitigating potential threats from automated entities.

The example embodiment may adjust a bot risk assessment associated with the potential bot candidate by analyzing a subset of the set of network traffic data corresponding to the potential bot candidate via an expert machine learning (ML) model (also referred to herein as a “heavyweight expert model,” an “expert model” and/or a “teacher model”) trained to detect attack vectors based on network traffic data associated with potential bot candidates. The example embodiment may further output the bot risk assessment associated with the potential bot candidate. Additional or alternative embodiments may further discover the potential bot candidate by processing the set of network traffic data via a lightweight discoverer ML model (also referred to herein as a “discoverer model”) trained to discover potential bot candidates from aggregate network traffic data. These techniques encompass a comprehensive approach that combines both lightweight and heavyweight ML models to analyze and evaluate entities based on their communication patterns, behaviors, and associated risk factors.

In today's digital landscape, networks are inundated with a myriad of entities, ranging from legitimate users to automated programs, commonly referred to as “bots.” While some bots perform benign or even beneficial tasks, such as web crawling for search engines, others have malicious intentions, attempting to exploit vulnerabilities, scrape sensitive data, or disrupt network services. These malicious entities, often termed “bad bots,” pose significant challenges to network operators and content providers, threatening the security, integrity, and availability of network resources.

The challenge of detecting bad bots has become increasingly complex. Traditional ML-based bot scoring systems may employ a one-stage approach, where an algorithm, such as random forest, evaluates traffic patterns based on various behavioral indicators like ramp-up time, volumetric anomalies, and location signals. While this approach is efficient, it often lacks the depth and granularity desired by network administrators. Some users (e.g., network administrators) may also seek deeper insights into the nature of the detected attacks, such as by further classifying bots into specific categories such as SQL injection, XSS attack, PII breaches, hacking attempts, volume-based attacks, and so forth. Moreover, the network administrators may wish to comprehend various factors contributing to the bot scores.

Some embodiments detailed herein introduce a server-side approach to entity evaluation, leveraging the power of machine learning to analyze network traffic data and assess the risk associated with entities that may represent potential bot candidates. By utilizing a multi-tiered system that includes a discoverer machine learning model and an expert machine learning model, these techniques may offer a nuanced and layered analysis, enhancing detection accuracy while minimizing user disruptions.

The discoverer model may serve as an initial filter, processing aggregate network traffic data to identify potential bot candidates. This model can extract signature information from entities based on their communication patterns, such as the unique URLs they traverse, data traffic volumes, and associated geographic locations.

Once potential bot candidates are identified, the expert model may delve deeper, analyzing specific attack vectors and adjusting the bot risk assessment accordingly. In some examples, the expert model may include and/or utilize multiple advanced models in a “mixture of experts” approach. By way of example, such advanced models may include Natural Language Processing (NLP) models such as Generative Pre-trained Transformer (GPT) models, vector embedding models (e.g., word2vec), and volumetric anomaly models that may discern finer patterns like request ramp-up times. With the ability to detect intricate attack vectors, embodiments may assign varying and nuanced scores or weights to different types of attacks based on their severity and impact.

Notably, certain embodiments may employ a self-supervised generative machine learning model (e.g., GPT) as at least part of the expert model. This model can utilize sessions from network traffic data as context windows and employ masked tokens for enhanced prediction capabilities. In some examples, a context window may refer to or include a sequence of text or data inputs that a model utilizes to generate predictions or outputs. It may encompass a range of tokens, sentences, or paragraphs that provide contextual information essential for understanding and generating coherent and relevant responses. The context window may vary in size and can be dynamically adjusted based on the model's requirements or the specific application. It may serve to enhance the model's ability to maintain consistency, relevance, and accuracy across a wide array of tasks, such as language translation, summarization, or conversation generation.

Additionally, masked tokens may refer to placeholders within a sequence of data or text that are intentionally obscured or hidden during the processing phase of a machine learning model. These tokens may be used to train models to predict or infer the masked content based on surrounding context. Masked tokens can enhance a model's ability to understand relationships and dependencies within data, thereby improving its predictive accuracy and generalization capabilities. They may be applied in various tasks, such as language modeling, data imputation, or context-based predictions, across different domains and applications. By analyzing both the signature and behavior of entities, this server-side approach offers a holistic view, enabling more accurate and efficient bot detection and risk assessment.

Moreover, some embodiments may employ reinforcement learning between the expert and discoverer models, allowing the predictions made by the expert model to serve as a labeled dataset for future predictions by the discoverer model. This dynamic may position the expert model as a mentor to the discoverer model. Validated attack vectors from the expert model can be integrated into a permanent label dataset, enriching future training sessions.

In general, a machine learning model may include and/or may be understood as a computational construct that is trained to make decisions or predictions based on data. Unlike traditional algorithms, which may present and/or follow explicit instructions to produce outcomes, machine learning models may identify patterns and may make decisions based on the insights they acquire.

A machine learning model may include an algorithm and a set of parameters fine-tuned during the training process. The training involves feeding the model a dataset and allowing it to make predictions or classifications. Over time, through iterative processes, the internal parameters of the model may be adjusted to minimize errors in predictions, thereby improving the model's accuracy. A machine learning model may serve as a dynamic tool, continually evolving and adapting to new data, enabling it to tackle complex problems and deliver insights that might be elusive to traditional algorithmic approaches.

There are various types of machine learning models, each suited for specific tasks. The following examples are provided for illustrative purposes only and do not limit the scope of this disclosure.

Supervised learning models are trained on labeled datasets, meaning the data is accompanied by the correct output. The model learns to map inputs to the correct outputs. Examples include regression models for predicting continuous values and classification models for categorizing data into specific classes.

Unlike supervised models, unsupervised learning models work with unlabeled data. They aim to find underlying structures or patterns in the data, such as clusters or groups. Common algorithms in this category include clustering and association algorithms.

Semi-supervised and self-supervised learning models operate in scenarios where only a portion of the data is labeled. They leverage both labeled and unlabeled data to improve learning accuracy. Self-supervised learning, a subset of this category, uses clever techniques to automatically generate supervisory signals from the input data.

Reinforcement learning models learn by interacting with an environment and receiving feedback in the form of rewards or penalties. They aim to find the best strategy or policy to achieve the highest cumulative reward over time.

Generative models learn to generate new data samples that resemble a given set of training samples. They can be used for tasks like image generation, style transfer, and more.

As will be described in greater detail below, in the context of evaluating entities communicating over a network, machine learning models can be particularly potent. They can analyze vast amounts of network traffic data, discern intricate patterns indicative of bot behavior, and make informed decisions about the potential risks associated with different entities. In some embodiments described herein, a multi-tiered system for evaluating entities communicating over a network may include a lightweight discoverer machine learning model and an expert machine learning model. By leveraging multiple machine learning models, embodiments of the systems and methods disclosed herein may enable network operators to achieve a nuanced understanding of entities communicating over a network, distinguishing between benign and potentially malicious actors with heightened accuracy.

A discoverer machine learning model, also sometimes referred to as a “lightweight discoverer model,” a “lightweight model,” a “shallow learning model,” a “student model,” and/or a “compact model,” may be designed and/or implemented with a primary objective of swift and efficient processing of vast amounts of data. In some embodiments described herein, a goal of this model may be to scan and identify potential entities of interest, such as potential bot candidates, from a large quantity of aggregate network traffic data. Given the “lightweight” nature, this model may be optimized for speed and scalability. It may be built to quickly sift through large datasets and flag potential entities for further analysis.

In contrast, an expert machine learning model, also sometimes referred to as a “deep neural network model,” a “teacher model,” and/or a “high-parameter model,” may be a more robust and intricate model tailored for a detailed analysis of potential threats. In some embodiments described herein, once potential bot candidates are identified by the lightweight model, the heavyweight model may thoroughly examine network traffic associated with the potential bot candidates to evaluate the potential bot candidates. This model may be specifically trained to detect intricate attack vectors based on the network traffic data associated with potential bot candidates. Given the “heavyweight” nature, the model may be more computationally intensive than the lightweight model, leveraging advanced algorithms and larger datasets to provide a detailed bot risk assessment. The model may offer a comprehensive analysis of the identified entities and may be trained to detect subtle patterns and attack vectors that might be overlooked by simpler models.

In some embodiments, differentiation between the two models may lie in their objectives and depth of analysis. The discoverer model may be geared towards the quick identification of potential bot candidates from a vast amount of network traffic data. In contrast, the heavyweight expert model may focus on providing a detailed risk assessment of these identified candidates. While the lightweight model may offer a preliminary scan, the heavyweight model may analyze intricate patterns and behaviors. In terms of computational intensity, the lightweight model may be optimized for speed and might use simpler algorithms to ensure rapid data processing. On the other hand, the heavyweight model, being more detailed, might be computationally more intensive, leveraging advanced machine learning techniques and larger training datasets. In some workflows, the lightweight model may act as the first line of defense, quickly scanning the network traffic and flagging potential bot candidates. These flagged entities may then be passed on to the heavyweight model for a detailed risk assessment.

In the context of machine learning, “features” and “parameters” may play different roles in model development and performance. Features may include or represent input variables or data attributes used by a model to make predictions or classifications. They may represent the characteristics of the data being analyzed. For example, in the evaluation of network traffic data, features might include the volume of traffic, the number of unique URLs accessed, or geographic location information. Features are crucial for providing the necessary context and information for the model to learn from and make informed decisions.

Parameters, on the other hand, may include internal variables of the model that may be adjusted during training. They may define how the model transforms input features into the desired output. In the context of the discoverer and expert machine learning models described herein, parameters are fine-tuned to improve the model's accuracy in identifying potential threats or bot candidates. For instance, the weights in a neural network are parameters that are optimized during training to minimize prediction errors.

In summary, while features may include or represent data inputs that describe a problem space, parameters may include or represent learned elements of the model that enable it to map those inputs to outputs effectively. The distinction between features and parameters may clarify how machine learning models operate and improve over time.

Some embodiments of the systems and methods described herein may relate to a multi-tiered system utilizes both a discoverer machine learning model and an expert machine learning model, each optimized for different aspects of data processing and analysis. The discoverer machine learning model, designed for quick and efficient data processing, may be characterized by a relatively (e.g., relative to the expert machine learning model) small parameter amount, ensuring rapid computation and scalability. This model may be tailored to sift through large volumes of network traffic data to identify potential bot candidates with minimal computational resources.

A parameter amount of the discoverer model may be defined within a lightweight model parameter amount threshold. In some embodiments, this threshold may include models with up to 1,000,000 parameters, models with parameter amounts ranging between 1,000,000 and 1,000,000,000 parameters, and so forth. This parameter range may enable the discoverer model to maintain efficiency and speed relative to the expert machine learning model and may be helpful for real-time data processing and/or preliminary threat identification.

In contrast, the expert machine learning model may be configured with a greater parameter amount relative to the discoverer machine learning model, making it a heavyweight model. This model may be equipped with sophisticated algorithms and extensive parameterization to provide a detailed analysis of potential threats. The parameter amount of the expert model may exceed a heavyweight model parameter amount threshold, which in some embodiments may include at least 1,000,000,000 parameters. Such complexity may allow the expert model to detect intricate attack vectors and perform comprehensive risk assessments.

The computational resource requirements for these models may also differ significantly. The expert model's complexity may result in a computing resource requirement (e.g., memory space and/or speed, processing power, electrical power, etc.) that exceeds a defined threshold, reflecting its need for more substantial computational power to execute detailed analyses. Conversely, the discoverer model may operate within this threshold (e.g., a parameter amount of the discoverer model may include an amount value fewer than a parameter amount of the expert machine learning model), optimized to perform its preliminary scanning tasks with reduced computational demands.

This differentiation in parameter amounts and computational resource requirements may illustrate complementary roles of the discoverer and expert models within the system. The discoverer model acts as a first line of defense, efficiently scanning network traffic to flag potential threats, while the expert model delivers an in-depth examination of these flagged threats, leveraging its advanced capabilities for thorough risk evaluation.

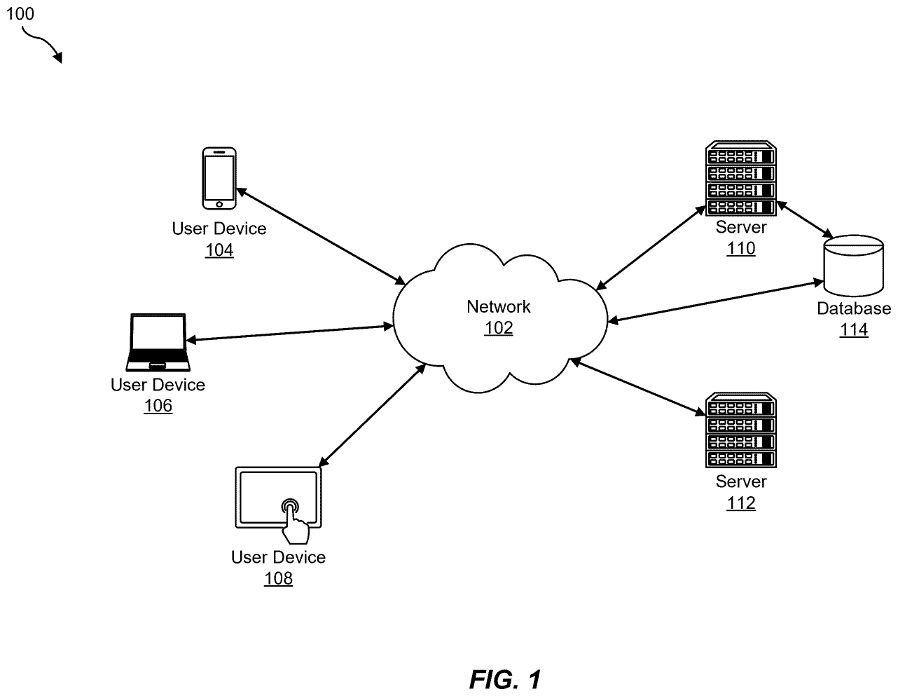

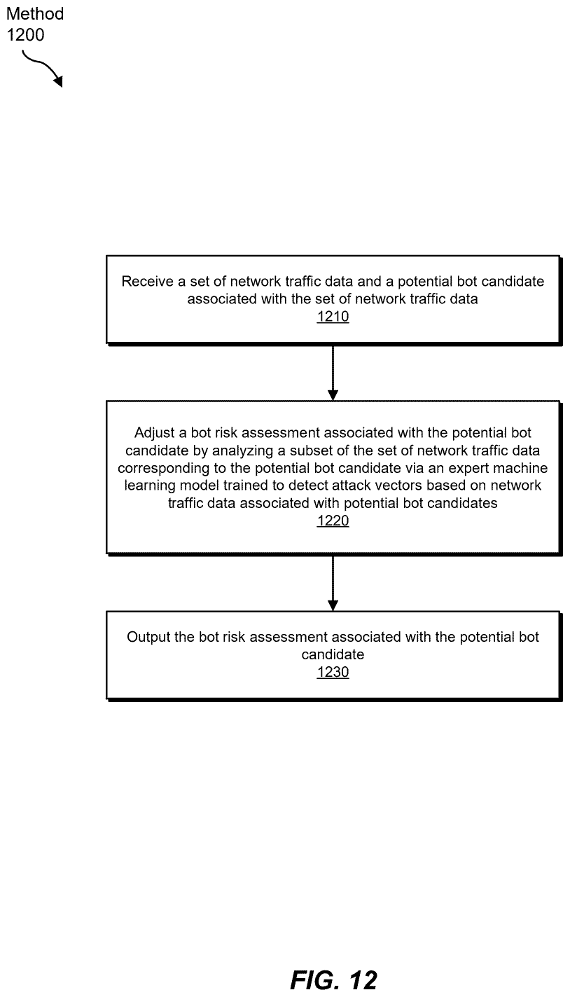

The following will provide, with reference to FIGS. 1-11, detailed descriptions of systems for evaluating entities communicating over a network. Detailed descriptions of corresponding computer-implemented methods will also be provided in connection with FIGS. 12-14. While some illustrative embodiments are described in connection with FIGS. 1-14, it should be appreciated that embodiments are not limited to being implemented in accordance with any of these examples. Other embodiments are possible and are contemplated within the scope of this disclosure.

FIG. 1 illustrates a system 100 within which some embodiments may operate. Not all the components of system 100 may be required to practice the disclosure, and variations in the arrangement and type of the components may be made without departing from the spirit or scope of the disclosure.

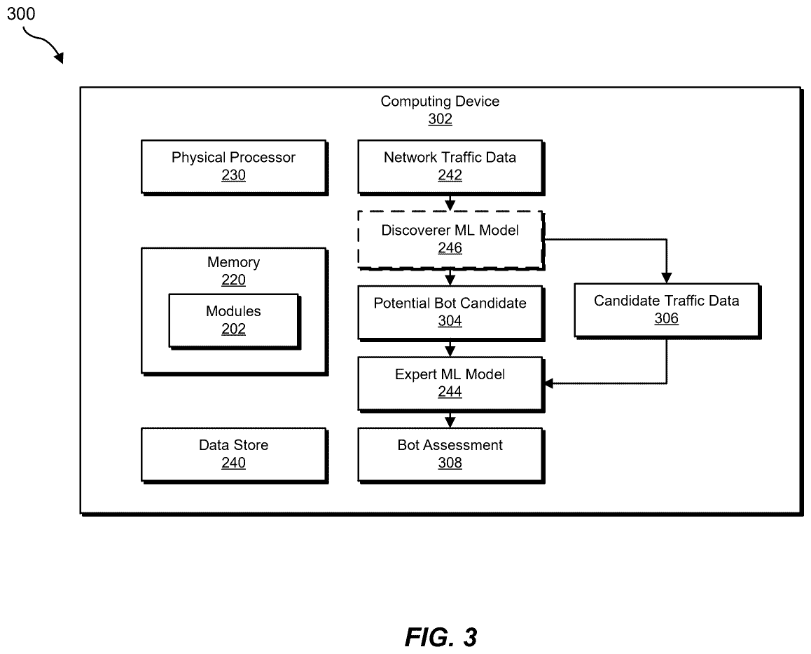

As shown, system 100 can include a network 102 and one or more user devices (e.g., user device 104 through user device 108) communicatively coupled to one or more servers (e.g., server 110 through server 112) via network 102. In some embodiments, a database 114 may be communicatively coupled to server 110 and/or network 102. User device 104 through user device 108 and/or server 110 through server 112 may be embodied on computing device 302 as discussed below in relation to FIG. 3. Generally, however, user device 104 through device 108 can include virtually any portable computing device capable of receiving and sending a message over a network, such as network 102. In some embodiments, user device 104 through user device 108 can also be described generally as client devices that are configured to be portable.

In some embodiments, user device 104 through user device 108 can also include at least one client application that is configured to receive content from another computing device such as one or more of server 110 through server 112. In some embodiments, the client application can include a capability to request, receive, render, and display textual content, graphical content, audio content, and the like. In some embodiments, the client application can further provide information that identifies itself, including a type, capability, name, version, and the like. One example of a client application is a web browser.

Network 102 may be or include any one or more times of wired and/or wireless, local- and/or wide-area communication network(s), including one or more enterprise networks and/or the Internet. Embodiments are not limited to operating with or within any particular type of network.

In some embodiments, network 102 can include any of a variety of wireless sub-networks that may further overlay stand-alone ad-hoc networks, and the like, to provide an infrastructure-oriented connection for user device 104 through user device 108, server 110 through server 112, and/or database 114. Such sub networks can include mesh networks, Wireless LAN (WLAN) networks, cellular networks, and the like. In some embodiments, a wireless network may include virtually any type of wireless communication mechanism by which signals may be communicated between computing devices.

Network 102 may be enabled to employ any form of communication media for communicating information from one electronic device to another. Also, network 102 can include the Internet in addition to local area networks (LANs), wide area networks (WANs), or direct connections. Moreover, network 102 may include not just local physical networks but also software-defined networks (SDNs), virtual private networks (VPNs), or any architecture capable of facilitating communication and data transfer across geographically and/or logically dispersed locations. In some cases, network 102 may not be restricted to a single physically restricted network but can be a collection of interconnected networks that operate as a single entity by virtue of software control or through virtual connections. According to some embodiments, a “network” should be understood to refer to a network that may couple devices so that communications may be exchanged (e.g., between a server and a client device) including between wireless devices coupled via a wireless network, for example. A network may also include mass storage or other forms of computer or machine-readable media, for example.

In some embodiments, network 102 may include one or more content delivery network(s). A “content delivery network” (sometimes also referred to as a “content distribution network”) (CDN) generally refers to a distributed content delivery system that comprises a collection of computers, computing devices, and servers linked by a network or networks.

In some embodiments, server 110 through server 112 may further provide a variety of services that include, but are not limited to, caching services, security services, email services, instant messaging (IM) services, streaming and/or downloading media services, search services, photo services, web services, social networking services, news services, third-party services, audio services, video services, mobile application services, or the like. Such services, for example can be provided via server 110 through server 112, whereby a user is able to utilize such service upon the user being authenticated, verified or identified by the service. In some embodiments, server 110 through server 112 can store, obtain, retrieve, or provide user data corresponding to the users of user device 104 through user device 108 or any other device on network 102, network traffic data for any device on network 102, internal logs of any of server 110 through server 112, or any other type of data that may be exchanged on network 102.

Server 110 through server 112 may be capable of sending or receiving signals, such as via a wired or wireless network, or may be capable of processing or storing signals, such as in memory as physical memory states. According to some embodiments, a “server” should be understood to refer to a service point which provides processing, database, and communication facilities. In some embodiments, the term “server” can refer to a single, physical processor with associated communications and data storage and database facilities, or it can refer to a networked or clustered complex of processors and associated network and storage devices, as well as operating software and one or more database systems and application software that support the services provided by the server. Cloud servers are examples.

Devices capable of operating as a server may include, as examples, dedicated rack-mounted servers, desktop computers, laptop computers, set top boxes, integrated devices combining various features, such as two or more features of the foregoing devices, or the like. In some embodiments, users are able to access services provided by server 110 through server 112 via the network 102 using their various device 104 through device 108.

In some embodiments, applications, such as, but not limited to, news applications (e.g., Yahoo!Sports®, ESPN®, Huffington Post®, CNN®, and the like), mail applications (e.g., Yahoo!Mail®, Gmail®, and the like), streaming video applications (e.g., YouTube®, Netflix®, Hulu®, iTunes®, Amazon Prime®, HBO Go®, and the like), instant messaging applications, blog, photo or social networking applications (e.g., Facebook®, Twitter®, Instagram®, and the like), search applications (e.g., Yahoo!® Search), and the like, can be hosted by servers 110 or other servers on network 102.

Thus, the server 110, for example, can store various types of applications and application related information including application data and user profile information (e.g., identifying and behavioral information associated with a user).

Moreover, although FIG. 1 illustrates server 110 and server 112 as single computing devices, respectively, the disclosure is not so limited. For example, one or more functions of server 110 through server 112 can be distributed across one or more distinct computing devices. Moreover, in one embodiment, server 110 and/or server 112 can be integrated into a single computing device, without departing from the scope of the present disclosure.

In some embodiments, server 110 may be configured to store and execute an entity evaluation facility that may operate in accordance with one or more techniques described herein to evaluate entities communicating via a network, such as to adjust an evaluation that may indicate a likelihood of whether any entity may be a bot. In some embodiments, the entity evaluation facility may analyze communications transmitted by a device of device 104 through device 108 to determine a type of an entity of a device (e.g., human users of or bots executing on the devices) that is transmitting such communications. The communications may be one or more messages sent by a device (e.g., one or more of device 104 through device 108) to the server 112, such as to request content be provided by the server 112 to the device. The server 110 may intercept or observe such message(s). For example, in an embodiment in which the system 100 includes a CDN, the server 110 and database 114 may be a part of the CDN, such as part of a point of presence (POP) of the CDN. The server 110 (or an entity executing thereon) may receive the message(s) to determine whether and/or how to operate on the message, such as to determine whether a message requests content that is cached by the CDN and can be served by the CDN instead of being served by the server 112. In accordance with techniques described herein, in analyzing the message(s), the entity evaluation facility may evaluate an entity from the message(s) and, on that basis, adjust a bot risk assessment associated with the entity. The evaluation may include analyzing messages transmitted contemporaneous with the evaluation, such as messages that are received and for which an analysis is done before or in parallel with determining whether to operate on the message. The evaluation may additionally and/or alternatively include analyzing messages previously transmitted, such as over any suitable prior time period. Such information may be stored in database 114 and may be retrieved using an identifier for an entity, such as a signature for the entity determined by the entity identification facility.

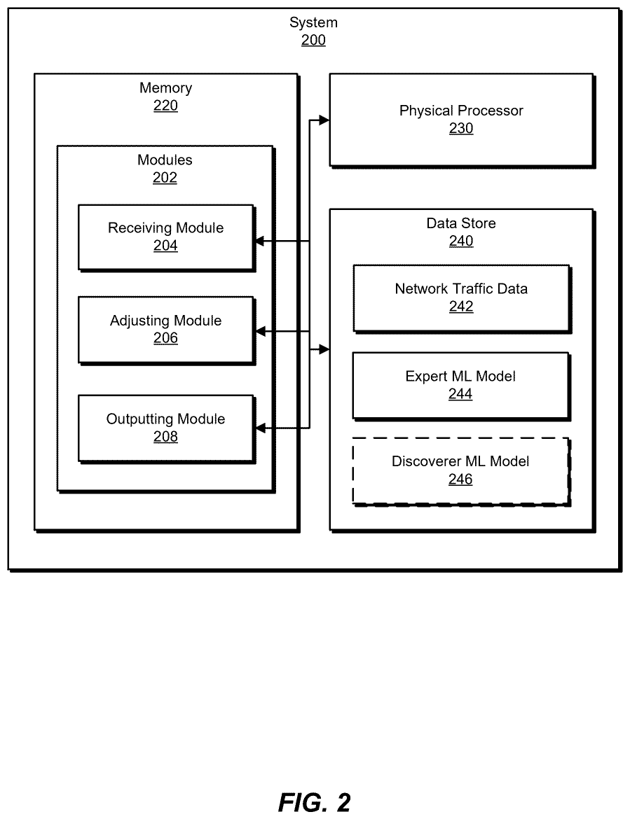

FIG. 2 is a block diagram of an example system 200 for evaluating entities communicating over a network. As illustrated in this figure, example system 200 may include one or more modules 202 for performing one or more tasks. As will be explained in greater detail below, modules 202 may include a receiving module 204 that may receive a set of network traffic data and a potential bot candidate associated with the set of network traffic data. Additionally, modules 202 may also include an adjusting module 206 that may adjust a bot risk assessment associated with the potential bot candidate by analyzing a subset of the set of network traffic data corresponding to the potential bot candidate via an expert machine learning model trained to detect attack vectors based on network traffic data associated with potential bot candidates. Furthermore, modules 202 may also include an outputting module 208 that output the bot risk assessment associated with the potential bot candidate.

Additionally, in accordance with some embodiments disclosed herein, one or more of modules 202 (e.g., adjusting module 206) may further discover, by processing the set of network traffic data via a discoverer machine learning model trained to discover potential bot candidates from aggregate network traffic data, the potential bot candidate.

Moreover, in some embodiments, one or more of modules 202 (e.g., one or more of receiving module 204, adjusting module 206, and/or outputting module 208) may receive a labeled dataset that may include aggregate network traffic data and at least one bot activity indicator. One or more of modules 202 may further extract fingerprinting features and behavior features from the labeled dataset, train a discoverer machine learning model using the fingerprinting features and behavior features to identify potential bot candidates based at least in part on the aggregate network traffic data, and store the discoverer machine learning model in a computer-readable storage medium.

Furthermore, in some embodiments, one or more of modules 202 (e.g., one or more of receiving module 204, adjusting module 206, and/or outputting module 208) may receive a labeled dataset comprising network traffic data associated with identified potential bot candidates, detect, by analyzing the labeled dataset, a plurality of potential attack vectors, train an expert machine learning model using the network traffic data to further analyze and adjust bot risk assessments for the identified potential bot candidates based on the potential attack vectors, and store the heavyweight expert machine learning model in a computer-readable storage medium.

As further illustrated in FIG. 2, example system 200 may also include one or more memory devices, such as memory 220. Memory 220 generally represents any type or form of volatile or non-volatile storage device or medium capable of storing data and/or computer-readable instructions. In one example, memory 220 may store, load, and/or maintain one or more of modules 202. Examples of memory 220 include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

As further illustrated in FIG. 2, example system 200 may also include one or more physical processors, such as physical processor 230. Physical processor 230 generally represents any type or form of hardware-implemented processing unit capable of interpreting and/or executing computer-readable instructions. In one example, physical processor 230 may access and/or modify one or more of modules 202 stored in memory 220. Additionally or alternatively, physical processor 230 may execute one or more of modules 202 to facilitate voice control of network management devices. Examples of physical processor 230 include, without limitation, microprocessors, microcontrollers, central processing units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

As also illustrated in FIG. 2, example system 200 may also include one or more stores of data, such as data store 240. Data store 240 may represent portions of a single data store or computing device or a plurality of data stores or computing devices. In some embodiments, data store 240 may be a logical container for data and may be implemented in various forms (e.g., a database, a file, file system, a data structure, etc.). Examples of data store 240 may include, without limitation, one or more files, file systems, data stores, databases, and/or database management systems such as an operational data store (ODS), a relational database, a NoSQL database, a NewSQL database, and/or any other suitable organized collection of data.

As further shown in FIG. 2, data store 240 may include network traffic data 242 and expert machine learning model 244 (“Expert ML Model 244” in FIG. 2). In some embodiments, data store 240 may also include a discoverer machine learning model 246 (“Discoverer ML Model” in FIG. 2).

In some examples, network traffic data 242 may include, refer to, or represent a collection or aggregation of data that represents the communication or exchange of information over a network. This data may encompass various elements, including but not limited to: source and destination information for data packets (e.g., IP addresses, domain names, port numbers, CDN identifiers, etc.), payload data (e.g., web page content, files, images, etc.), and/or metadata (e.g., timestamps, packet sizes, protocol types, etc.).

Additionally or alternatively, network traffic data 242 may include data representative of behavioral patterns that may indicate user behavior or system behavior. For example, rapid consecutive requests to a server could indicate potential bot activity.

In some examples, network traffic data 242 may additionally or alternatively include data representative of logs, i.e., records generated by network devices, applications, or services that provide detailed information about network activities. Examples may include, without limitation, Web Application Firewall (WAF) logs, IP domain logs, and business access (BE) logs. Moreover, network traffic data 242 may additionally or alternatively include session information. Such data related to a specific user session could include details like session duration, pages accessed, and frequency of requests. Furthermore, in some examples, network traffic data 242 may additionally or alternatively include information associated with any anomalies or irregularities associated with network traffic. Any unusual patterns or activities that deviate from the norm, which could be indicative of potential threats or malicious activities.

In some embodiments disclosed herein, this set of network traffic data may serve as input data that is ingested, processed, and analyzed to detect potential bot candidates and assess bot-related risks. The data may provide a comprehensive view of network activities, enabling the system to make informed decisions about potential threats based on a holistic understanding of the network traffic.

In some examples, expert machine learning model 244 may include or represent a sophisticated computational model tailored for in-depth analysis and evaluation of intricate patterns within data. Unlike simpler models that might be designed for swift processing of vast amounts of data, an expert machine learning model like expert machine learning model 244 may delve deeper into the nuances of the data it processes. It may be characterized by an ability to leverage advanced algorithms, often encompassing multiple layers and potentially millions or billions of parameters. Such models are particularly adept at detecting subtle patterns, behaviors, and attack vectors that might be overlooked by less intricate models.

As will be described in greater detail below, in some embodiments, expert machine learning model 244 may be employed by one or more of modules 202 to provide a comprehensive risk assessment of potential bot candidates identified from network traffic data 242. By analyzing the network traffic associated with these candidates, the model may evaluate a nature and extent of potential threats. Given its “expert” designation, expert machine learning model 244 may be computationally intensive, possibly requiring more resources and time compared to lightweight models. Even with this possibly increased resource requirement, expert machine learning model 244 may provide a higher degree of accuracy and detail in its analysis, making it invaluable for tasks that demand precision and depth of understanding.

In some examples, discoverer machine learning model 246 may include or represent a streamlined computational model designed primarily for the rapid and efficient processing of extensive datasets. This model may be optimized for speed, enabling it to swiftly scan and identify entities of interest from large volumes of data, such as potential bot candidates from aggregate network traffic data. Given its “lightweight” nature, it may be constructed to ensure scalability, allowing it to handle vast amounts of data without significant computational overhead.

Unlike more complex models that may provide detailed analyses, the discoverer model may be focused on preliminary scans, using simpler algorithms to achieve its objectives. For instance, in some embodiments disclosed herein, discoverer machine learning model 246 may act as an initial filter, sifting through network traffic to flag potential entities for further scrutiny. The efficiency of the discoverer model may be further underscored by a use of non-deep learning algorithms, such as XGboost and/or Logistic Regression, which are known for speed and efficiency. These algorithms, combined with the model's design, ensure that it remains agile and responsive, making it an essential tool for tasks that require rapid data processing and preliminary identification.

Example system 200 in FIG. 2 may be implemented in a variety of ways. For example, all or a portion of example system 200 may represent portions of an example system 300 in FIG. 3.

FIG. 3 is a block diagram of an example system 200 that implements a system for evaluating entities communicating over a network. As shown in FIG. 3, example system 300 may include a computing device 302. In at least one example, computing device 302 may be programmed with one or more of modules 202.

In some examples, one or more of modules 202 from FIG. 2 may, when executed by one or more physical processors included in computing device 302 (e.g., physical processor 230), cause computing device 302 to perform one or more operations to enable evaluation of entities communicating over a network. For example, as will be described in greater detail below, receiving module 204 may cause computing device 302 to receive a set of network traffic data (e.g., network traffic data 242) and a potential bot candidate associated with the set of network traffic data (e.g., potential bot candidate 304). Additionally, adjusting module 206 may cause computing device 302 to adjust a bot risk assessment associated with the potential bot candidate (e.g., bot assessment 308) by analyzing a subset of the set of network traffic data corresponding to the potential bot candidate via an expert machine learning model trained to detect attack vectors based on network traffic data associated with potential bot candidates (e.g., expert ML model 244). Moreover, outputting module 208 may cause computing device 302 to output the bot risk assessment associated with the potential bot candidate.

Furthermore, in some embodiments, one or more of modules 202 may cause computing device 302 to discover, by processing the set of network traffic data via a discoverer machine learning model trained to discover potential bot candidates from aggregate network traffic data (e.g., discoverer ML model 246), the potential bot candidate.

Many other devices or subsystems may be connected to example system 200 in FIG. 2 and/or example system 300 in FIG. 3. Conversely, all of the components and devices illustrated in FIG. 2 and FIG. 3 need not be present to practice the embodiments described and/or illustrated herein. The devices and subsystems referenced above may also be interconnected in different ways from those shown in FIG. 3. Example system 200 and example system 300 may also employ any number of software, firmware, and/or hardware configurations. For example, one or more of the example embodiments disclosed herein may be encoded as a computer program (also referred to as computer software, software applications, computer-readable instructions, and/or computer control logic) on a transitory and/or non-transitory computer-readable medium.

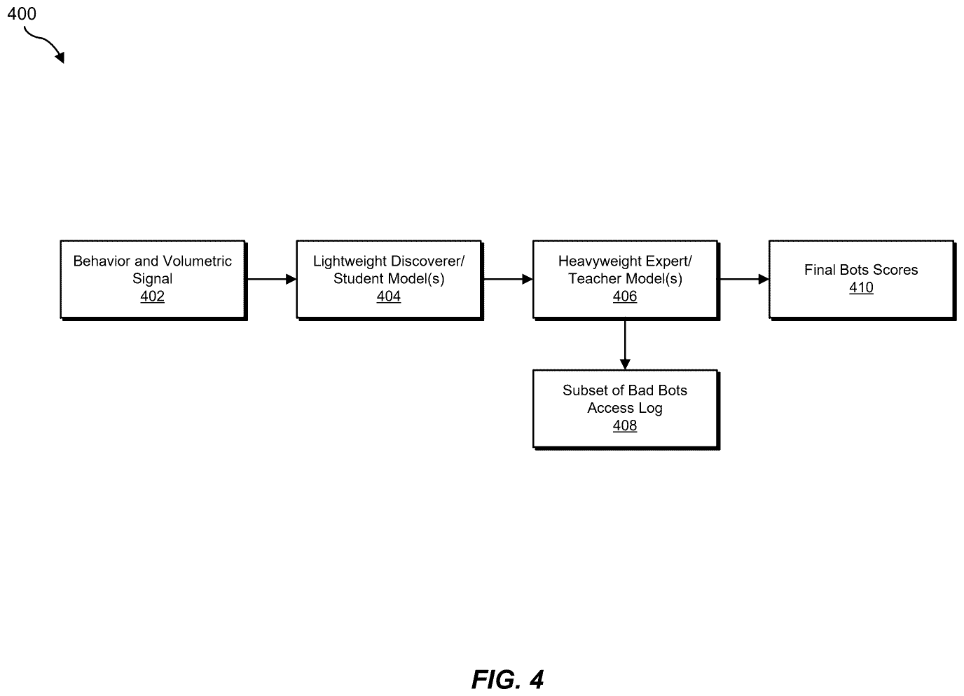

FIG. 4 is a flow diagram 400 that illustrates a basic operational flow for an example system for evaluating entities communicating over a network in accordance with some embodiments described herein. Flow diagram 400 presents a structured overview of a multi-tiered approach to bot detection and scoring using both lightweight and heavyweight machine learning models.

Behavior and volumetric signal 402 represents an initial set of data, encompassing both behavioral patterns and volumetric signals associated with network traffic. Such data provides insights into the patterns of activity and the volume of requests, which are essential indicators for potential bot activity. In some examples, behavior and volumetric signal 402 may be included in and/or represented by network traffic data 242.

Lightweight discoverer/student model(s) 404 may be optimized for rapid processing and scalability. It may serve as a preliminary filter, quickly scanning the behavioral and volumetric signals to identify potential bot candidates. As the name “Discoverer/Student” suggests, this model may be designed to discover potential threats and learn from them, but it may not delve into the intricate details of each potential threat. In some examples, lightweight discoverer/student model(s) 404 may be included in and/or represented by discoverer machine learning model 246.

Heavyweight expert/teacher model(s) 406 may then use the potential bot candidates identified by the lightweight model. Heavyweight expert/teacher model(s) 406 may be more robust and detailed than the lightweight discoverer/student model(s) 404 and may be designed to conduct a thorough analysis of the potential threats. Leveraging advanced algorithms and larger datasets, this heavyweight model may examine the data in-depth to validate the potential bot candidates and determine the nature and severity of the threat they pose. As the “Expert/Teacher” designation implies, this model serves as a more knowledgeable entity, providing expert analysis and potentially guiding or refining the decisions of the lightweight model. In some examples, heavyweight expert/teacher model(s) 406 may be included in and/or represented by expert ML model 244.

Subset of bad bots access log 408 is then generated. This subset represents confirmed bot activities filtered out from the general traffic and may provide a focused view of malicious activities. In some examples, subset of bad bots access log 408 may be included in and/or represented at least in part by network traffic data 242.

Also, and in some embodiments, final bots scores 410 may be generated, which may provide a comprehensive risk assessment of the detected bots. These scores (in some embodiments, also accompanied by more detailed evaluations) may offer a quantified measure of the threat level posed by each detected bot, allowing for prioritized responses and actions. In some examples, final bots scores 410 may be included in and/or represented by bot assessment 308.

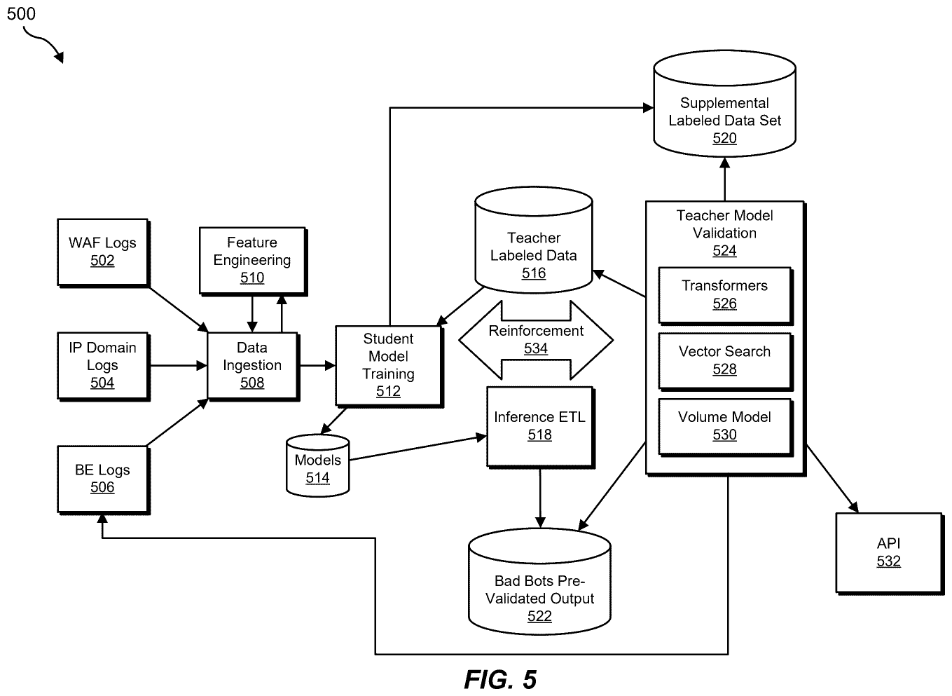

FIG. 5 is a block diagram illustrating an example system 500 that implements an example system for evaluating entities communicating over a network in accordance with some embodiments of the present disclosure. The processes shown in FIG. 5 may be performed by one or more of modules 202 when executed by one or more physical processors, such as physical processor 230. Likewise, the data objects and/or data stores shown in FIG. 5 may be included within and/or included as part of data store 240, network traffic data 242, expert machine learning model 244, and/or discoverer machine learning model 246. Additional description and detail of the data, processes, models, and outputs shown in FIG. 5 will be provided below.

As shown, example system 500 includes a variety of data objects such as WAF logs 502, Internet Protocol (IP) domain logs 504, and business access (BE) logs 506. These logs may act as some of the foundational data sources for example system 500, and each may be included as part of network traffic data 242 in data store 240. As shown, data from these logs may be directed into a data store named data ingestion 508, indicating that the data from all these logs is consolidated and stored within this data store.

Post data ingestion, the data undergoes a process termed feature engineering 510. The data ingestion 508 data store supplies data to feature engineering 510. As also shown in FIG. 5, a feedback loop may exist between feature engineering 510 and the data ingestion 508 data store. This may suggest an iterative refinement or preprocessing of the ingested data based on the features that are engineered.

Data ingestion 508 and/or feature engineering 510 may represent portions of a data ingestion layer or process that may be configured to process and/or consolidate incoming data from foundational sources like WAF logs 502, IP logs 504, and/or BE logs 506. In some embodiments, this layer may periodically consume behavior and payload features from an enterprise Online Analytical Processing (OLAP) system. Some embodiments may use an open-source column-oriented database management system (e.g., ClickHouse®) for efficient data storage and retrieval. Example system 500 may calculate running means and distinct values, enabling delta analysis to adjust features (e.g., feature engineering 510) based on new data while considering past aggregates. Additionally, signals from CDN access may enhance the system's traffic analysis capabilities. Notably, the data ingestion pipeline may operate in near real-time, ensuring timely threat detection and response by continuously updating with recent data.

The system shown in FIG. 5 further incorporates a process called student model training 512 that receives data from both data ingestion 508 and feature engineering 510. This shows that the model training process leverages both the raw and feature-engineered data. The models that result from this training (e.g., discoverer machine learning model 246) may be stored in the models 514 data store. Additionally, the student model training 512 process interacts with a supplemental labeled data set 520 data store, showing that the student model training 512 may be utilized to augment or refine supplemental labeled dataset 520.

In some embodiments, student models (e.g., discoverer machine learning model 246) may utilize both anomaly detection and supervised learning based on aggregate features. These features may include, but are not limited to, a traffic volume between source and target hosts, unique URLs navigated by a host, geographical location signals, and a ratio of specific JA3 fingerprints, JA4 fingerprints, and/or IP addresses tagged with the WAF.

In some embodiments, a student model (e.g., discoverer machine learning model 246) may employ multiple sets of features, such as fingerprinting features and/or behavior features. The fingerprinting features may include, without limitation, a JA3 fingerprint, a JA4 fingerprint, a User Agent, source IP address, and/or Autonomous System Number (ASN) that may serve as unique identifiers. The behavior features may include details of the request, considering metrics like volume, URL, referrer, host, known bot characteristics, bytes_in, bytes_out, total_connection_time, total_write_time, and uniqueurlperhost, among others.

Mentioned above, a JA3 fingerprint may include a method used to uniquely identify SSL/TLS clients (typically a web browser or an application making HTTPS connections) based on the properties of the SSL/TLS handshake. During a SSL/TLS handshake, which is the initial exchange to establish a secure connection, the client sends specific parameters to the server. JA3 captures this data, which may include a version of SSL/TLS being used, cipher suites supported by the client, extensions (e.g., Server Name Indication, Application-Layer Protocol Negotiation), elliptic curve information, and/or an elliptic curve point form. These elements are hashed to create a fingerprint that represents the client's SSL/TLS setup in a condensed form. This fingerprint, called a JA3 hash, is a unique identifier for the client and can be used to detect patterns or anomalies, particularly in network security.

A JA4 fingerprint is similar to the JA3 fingerprint but may be designed to identify SSL/TLS servers rather than clients. While JA3 fingerprints may capture the properties of a client during the SSL/TLS handshake, JA4 fingerprints may capture the corresponding properties of a server's response. During this handshake, the server may respond to the client with its own set of SSL/TLS parameters, including the chosen SSL/TLS version, selected cipher suite, supported extensions, elliptic curve information, and elliptic curve point format. JA4 may capture these server-specific elements and hash them into a unique identifier, known as a JA4 hash, which serves as a unique fingerprint for the server's SSL/TLS setup.

A key design principle of a discoverer model (e.g., discoverer machine learning model 246) may be scalability. A discoverer model may be designed and/or implemented to handle vast datasets efficiently, leveraging aggregate statistics computed by a high-performance columnar database (e.g., ClickHouse®). This may ensure timely and efficient traffic evaluation.

In some examples, a discoverer model (e.g., discoverer machine learning model 246) may include a supervised learning model and/or a volumetric anomalies model. In some embodiments, the supervised learning model may be implemented using XGBoost, a gradient boosting framework that employs decision trees. Such a supervised learning model may be specifically trained on a labeled dataset derived from a WAF and/or WAF log (e.g., WAF logs 502) to discern potential bot activities. By leveraging features extracted from behavioral analysis, the XGBoost model may assign a probability score during the inference stage, indicating the likelihood of the traffic originating from bots. In at least one embodiment, this model may be implemented via Apache Spark, an open-source, distributed computing system that provides an interface for programming entire clusters with implicit data parallelism and fault tolerance. Such an implementation may enable the model to process vast amounts of features, allowing it to handle millions of features in batches, typically processed in intervals of 30 minutes.

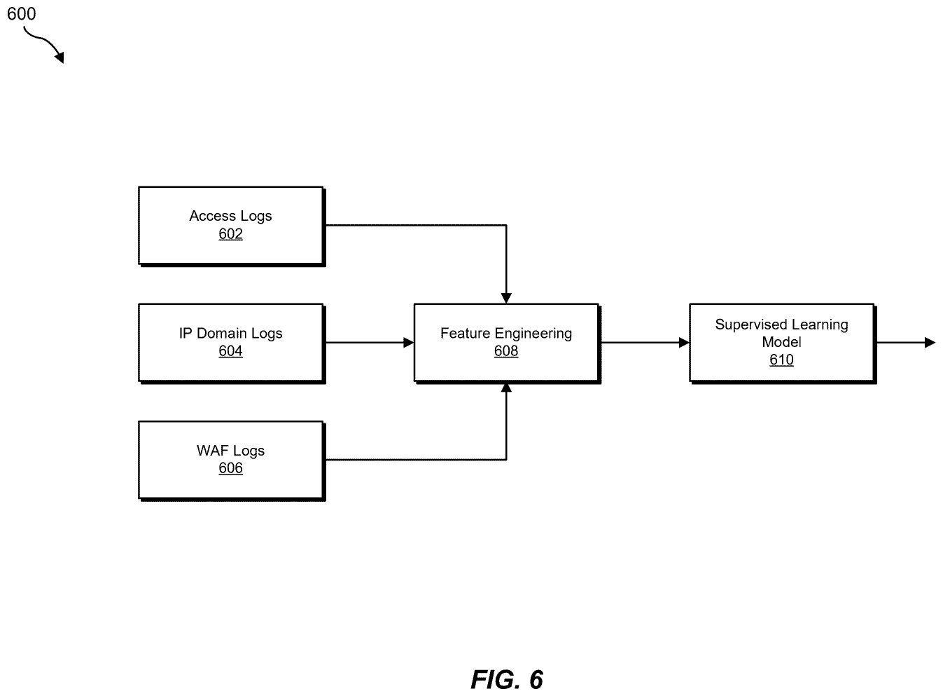

FIG. 6 includes a block diagram 600 that illustrates a possible architecture for a supervised learning model in accordance with some embodiments disclosed herein. As shown, the system (e.g., example system 200, example system 300, example system 500, etc.) may ingest various data sources, including access logs 602, IP domain logs 604, and WAF logs 606. These logs may be directed into the feature engineering block 608, where relevant features may be extracted and processed. The processed data may then be fed into the supervised learning model 610, where the model may evaluate the data and assign bot probability scores based on its training.

In some embodiments, a volumetric anomalies model may employ the same behavioral features as the supervised learning model. However, a distinguishing factor may be that a volumetric anomalies model may not rely on WAF signals for labeling. Instead, a volumetric anomalies model may be an unsupervised algorithm that utilizes statistical methods, such as (without limitation) Z-Score, quantiles, and/or isolated forests, to pinpoint volumetric anomalies in the data.

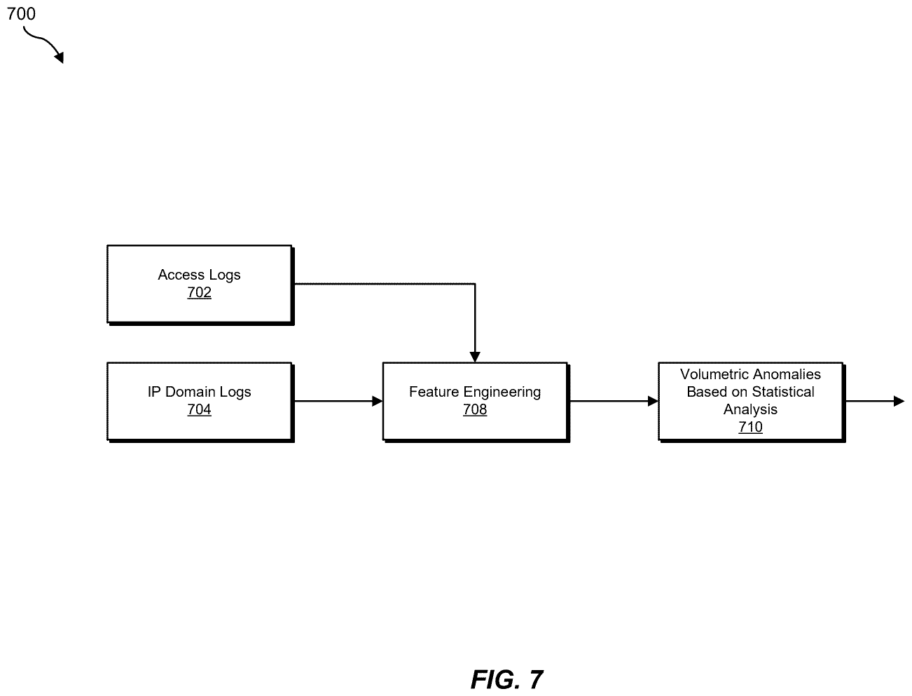

FIG. 7 includes a block diagram 700 that illustrates a possible architecture for a volumetric anomalies model in accordance with some embodiments disclosed herein. As shown, the system (e.g., example system 200, example system 300, example system 500, etc.) may ingest data from access logs 702 and IP domain logs 704, directing them to the feature engineering block 708. Here, relevant features are extracted and processed similarly to the supervised model. The processed data is then channeled to the volumetric anomalies based on statistical analysis block 710. In this block, the model identifies potential volumetric anomalies by analyzing statistical properties of the data.

Returning to FIG. 5, the models 514 data store may provide input to an inference extraction, transformation, and loading (ETL) 518 process, which may process the outputs of the models and may channel them into a bad bots pre-validated output 522 data store. This indicates a process that the inferences from the models may undergo before being categorized or identified as potential bot activities.

An important component within the example system 500 may be the teacher model validation 524 process. This process interfaces with the teacher labeled data 516 data store, the supplemental labeled data set 520, the bad bots pre-validated output 522 data store, and an application programming interface 532 (API 532). This interaction indicates a thorough validation process where the teacher model validates and potentially refines the outputs based on various labeled datasets and pre-validated outputs. The validated outputs can then be accessed or retrieved via the API 532.

Contained within the teacher model validation 524 are three distinct processes: transformers 526, vector search 528, and volume model 530. These processes represent different methodologies or techniques employed by the teacher model (e.g., expert machine learning model 244) during the validation process.

As described above in reference to FIG. 4, in some embodiments, a disclosed architecture may be designed to operate in stages, with each stage progressively refining the analysis of potential bot activities. The first stage (e.g., discoverer machine learning model 246) may primarily focus on identifying potential bot candidates by analyzing aggregate behaviors. Once these potential candidates are identified, they may be passed on to the second stage (e.g., expert machine learning model 244) for a more granular examination.

In this second stage, some embodiments of the disclosed techniques may delve deeper into the subset of signals that were filtered out by the first stage. Embodiments may meticulously analyze individual requests and their associated payloads. The objective of this detailed analysis is twofold: firstly, to identify the specific type of threat or anomaly present, and secondly, to generate an explanatory report that sheds light on the findings. This report not only provides insights into the identified threats but also adjusts the risk score based on the explanations provided.

This second stage may include an ensemble of expert models, often referred to as the teacher model or expert model. This ensemble may be dynamic in nature, allowing for the addition or removal of individual models. The final risk score generated by this stage is a combination of the scores produced by the ensemble. In some embodiments, an ensemble function may employ a weighted linear average to combine these scores, but this approach is flexible and can be modified or replaced in future iterations to optimize performance or adapt to new threat landscapes.

The second stage (e.g., expert machine learning model 244) may be equipped to classify a wide range of threats. Among the classifications it can perform (without limitation) are SQL Injection, where malicious SQL code is inserted into an entry field for execution to potentially breach database security; Cross-Site Scripting (XSS) Injection attacks, where scripts are injected into web pages viewed by other users, potentially compromising user data; Javascript Injection, involving the insertion of malicious JavaScript code into web applications; Scrapper Bots, which are designed to scrape content from websites often without permission; Remote Command Injections, which are attacks where arbitrary commands are executed on a host operating system via a vulnerable application; Volume Extreme Value Anomaly, which detects unusual spikes or drops in traffic volume indicating bot activity; and Ramp Up Time Anomaly, which identifies abnormal patterns in the time taken for traffic to increase, potentially indicative of coordinated bot attacks.

As noted above this second stage may include a generative model such as a GPT model (e.g., transformers 526), a vector search model (e.g., vector search 528), and a volumetric anomaly model (e.g., volume model 530). These models may represent different methodologies or techniques employed by the teacher model (e.g., expert machine learning model 244).

The volumetric anomaly model employed in the second stage (e.g., volume model 530) may be similar to the volumetric anomaly model employed in the first stage. However, in some embodiments the volumetric anomalies model may be used for a different purpose in second stage as compared to first stage and may only be used to identify subsets of access logs filtered by first model.

The volumetric anomaly model serves a specialized role in the second stage of the system's analysis. While the primary function of this model in the first stage is to identify potential bot candidates based on aggregate behavior, its role in the second stage is more nuanced. Specifically, in this latter stage, the volumetric anomaly model is employed to detect scraper bots and other malicious entities that might consistently ping the system. Such bots can be resource-intensive, draining system resources even if their payloads appear benign at first glance.

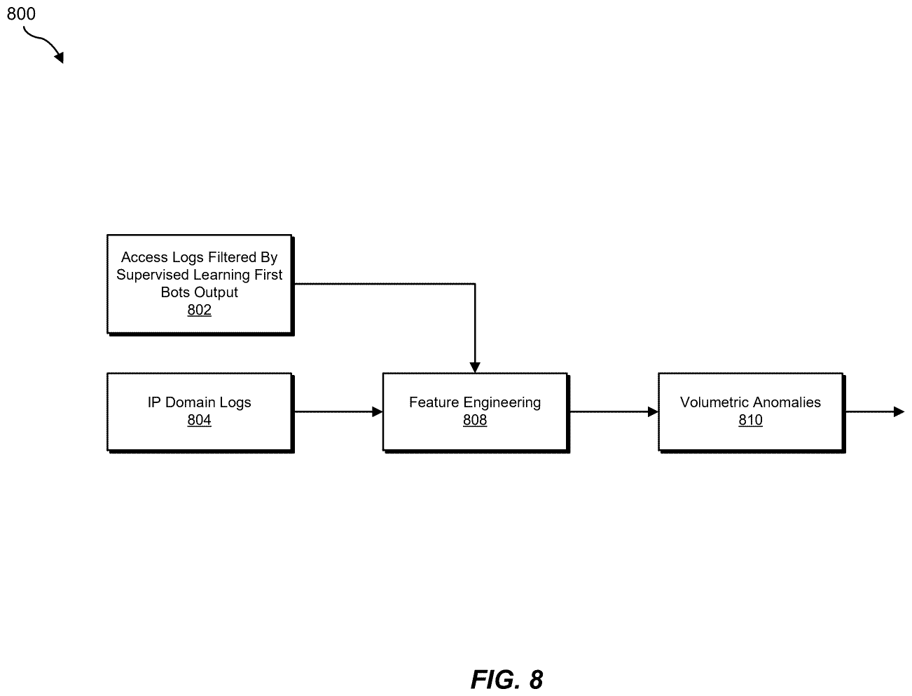

FIG. 8 includes a block diagram 800 that provides a visual representation of a data flow and processing steps involved in this second-stage volumetric anomaly detection. At access logs filtered by supervised learning first bots output 802, these logs, which have already been pre-filtered by the first-stage model (e.g., discoverer machine learning model 246), are directed into feature engineering 808 for extraction and processing of relevant features from the access logs. Additionally, IP domain logs 804 also feed into the feature engineering block, providing another layer of data for analysis.

Once the feature engineering process is complete, the processed data is then directed to volumetric anomalies 810. Here, the actual detection of volumetric anomalies takes place. The volumetric anomaly model analyzes the engineered features to identify patterns or behaviors indicative of scraper bots or other bots that might be engaging in resource-draining activities. Through this process, the system can pinpoint specific bots or entities that, while not immediately flagged in the first stage, exhibit suspicious behavior upon closer examination in the second stage.

In the second stage of the system's analysis, an attack vector model is employed to further scrutinize and classify potential threats. One implementation may use embeddings and vector search (e.g., vector search 528). In some examples, such an implementation may incorporate a word2vec based model. In some examples, word2vec may be a popular technique in the field of natural language processing (NLP) that aims to represent words in a continuous vector space, which may provide a way to convert textual information into a numerical form that can be understood and processed by machine learning algorithms.

A labeled dataset sourced from a WAF may be utilized post the session creation phase. This labeled dataset may serve as a foundation upon which the word2vec model may be trained, enabling it to learn and understand the embedding space for these vectors. Once trained, these embeddings, which essentially are compact representations of the data, are stored in specialized vector stores. One such vector store may be Pinecone®.

During the inference phase, traffic from access logs is tokenized and sessionized. The trained word2vec model may then transform this tokenized data into embeddings. The system may proceed to perform a nearest neighbor search, specifically seeking out the K-nearest neighbors within the vector store. The vector store (e.g., Pinecone) may aid in this search, providing efficient and accurate results.

Based on the proximity and characteristics of the nearest neighbors, the input payload is classified into specific attack vector types. For instance, if the nearest neighbors exhibit patterns consistent with SQL Injection attacks, the input payload would be classified as such.

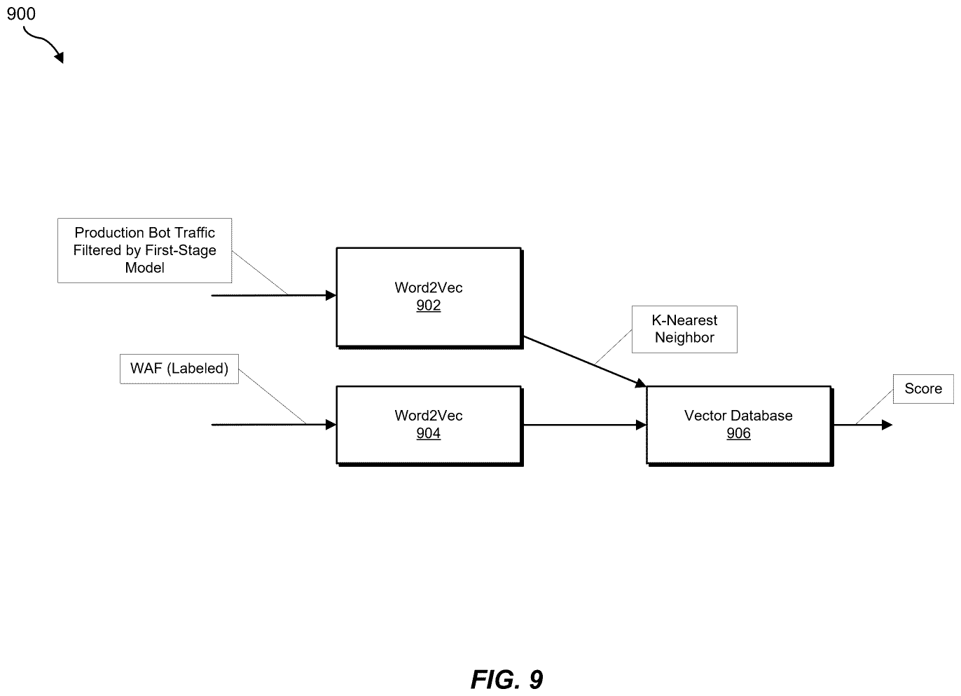

FIG. 9 includes a block diagram 900 that provides a visual representation of a process for making inferences using a vector space model in accordance with some embodiments disclosed herein. As shown, production bot traffic filtered by first-stage model is received into the word2vec 902 process. Simultaneously, WAF labeled data feeds into the word2vec 904 process. Both these processes interface with a vector database 906, where the K-Nearest Neighbor search is conducted. The final outcome, represented as a score, is then relayed out of the diagram, providing a quantifiable measure of the potential threat.

An additional or alternative implementation of an attack vector model may be based on NLP and/or generative transformers such as GPT. This generative transformer model (e.g., transformers 526) may not be only adept at categorizing attack vectors but also may possess the capability to generate them. As mentioned above, the generative model may interpret a session as a context window or paragraph. Within this context, the model's objective is to predict the subsequent token based on the preceding ones in the session. The model may be fine-tuned using a combination of labeled data sourced from filtered WAF logs and unlabeled data from access logs. In some examples, a generative transformer may be pre-trained using a particular corpus. For example, a generative transformer may include GPT-Code-Clippy (GPT-CC), a language model that is fine-tuned on publicly available code from GitHub®.

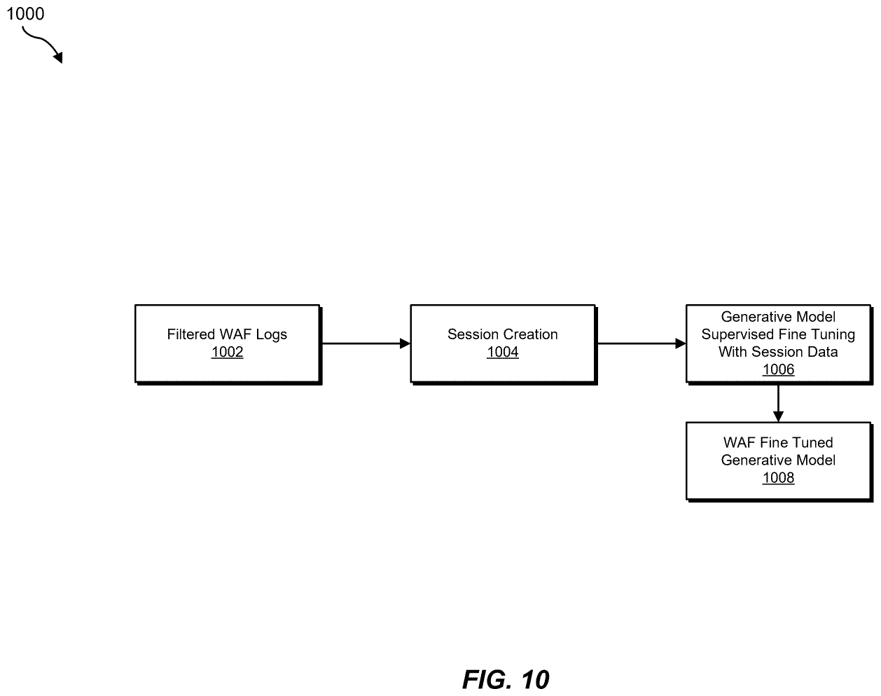

FIG. 10 includes a block diagram 1000 that provides a visual representation of a process flow related to the utilization and fine-tuning of a generative model using WAF logs. The process begins with filtered WAF logs 1002 which are used as labeled data. These logs have undergone a filtering process to ensure that only relevant and pertinent data is considered for subsequent steps.

At session creation 1004, the filtered WAF logs are aggregated and organized into sessions. By grouping the logs into sessions, the system can better understand and analyze patterns, behaviors, and potential threats within a specific timeframe or context.

A session, in this context, may include continuous activity between a host and target within a predetermined period of time, such as less than 5 minutes. The raw payload from a given host within a session can comprise various activities originating from entities like IP addresses or ASNs. To convert this payload into tokens, Byte Pair Encoding (BPE) is employed. The generative model may predict the subsequent token based on its predecessor. Through fine-tuning, the generative model can generate labels based on the likelihood of tokens across the entire corpora space.

Once the sessions are created, the sessions are used as part of a generative model supervised fine-tuning process with session data 1006. This fine-tuning ensures that the model is better equipped to recognize and understand patterns specific to the provided session data, enhancing its accuracy and predictive capabilities. This process results in the WAF fine-tuned generative model 1008. This model has been specifically adapted to the characteristics and patterns found in the WAF logs and is now ready for deployment or further analysis.

Returning to FIG. 5, reinforcement 534 establishes a bidirectional relationship between student model training 512 and the teacher model validation 524. This reinforcement mechanism signifies a feedback loop between the training of the student model (e.g., discoverer machine learning model 246) and the validation performed by the teacher model (e.g., expert machine learning model 244).

The bidirectional nature of reinforcement 534 indicates that the results and insights gained from the teacher model's validation process are fed back into the student model's training process. This feedback mechanism allows the student model to learn from its mistakes, refine its parameters, and improve its performance in subsequent training iterations. Conversely, the student model's outputs, especially those that are correctly predicted or classified, can provide the teacher model with additional data points to refine its validation criteria.

Furthermore, the reinforcement mechanism ensures a dynamic and adaptive learning environment. As the student model evolves and improves, the teacher model continually adjusts its validation techniques, ensuring that the student model is always held to the highest standards of accuracy and reliability.

Hence, teacher model validation 524 not only validates the outputs of student model training 512 but also actively readjusts the scores generated by the student model. This adjustment process enhances the quality of the scores, ensuring they are more accurate and reliable.

The refined scores introduced by the teacher model serve multiple purposes. Firstly, they act as a reinforcement learning policy. In some examples, this reinforcement learning policy may influence volume model 530 by adjusting its weights, optimizing it to better recognize and process patterns in the data. The reinforcement learning policy ensures that the system continually adapts and improves its performance based on feedback from the teacher model.

Secondly, the updated scores from the teacher model also provide an additional labeled data source for student model training 512. This supplemental data aids in refining the training process of the student model, allowing it to learn from the insights and expertise of the teacher model. By incorporating this feedback into its training data, the student model can enhance its predictive capabilities and reduce errors in future iterations.

Thus, the reinforcement learning mechanism (e.g., reinforcement 534) establishes a dynamic feedback loop between the student and teacher models. This loop ensures continuous improvement, with the teacher model guiding the student model towards better performance, while simultaneously refining its own validation criteria based on the student model's outputs.

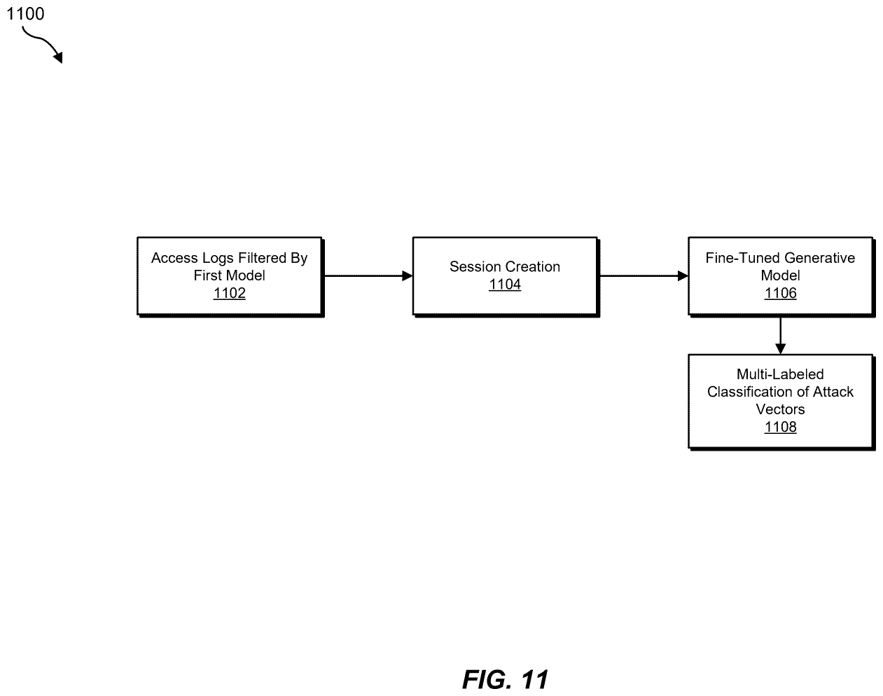

FIG. 11 includes a block diagram 1100 that provides a visual representation of a process flow that leverages a fine-tuned generative model to classify attack vectors from access logs.

Access logs filtered by first model 1102 may represent an initial set of data that has been pre-processed or filtered by an initial model (e.g., a lightweight discoverer machine learning model, another heavyweight expert machine learning model, etc.) to ensure that only relevant and potentially suspicious activities are considered for the subsequent steps. This filtering step may reduce noise and focus on potential threats.

The filtered access log data is then used for session creation 1104. Here, the filtered access logs are organized into sessions. Grouping the logs into sessions allows for a more contextual analysis, as it provides a structured view of user or entity behaviors over a specific duration or context.

Once the sessions are established, fine-tuned generative model 1106 is applied to the sessions. The generative model may have been specifically fine-tuned to recognize patterns, behaviors, and potential threats within the context of the provided session data. The fine-tuning process ensures that the model is adept at identifying subtle nuances and patterns indicative of various attack vectors.

The model's predictions or inferences are then classified into multiple labels representing different types of attack vectors at multi-labeled classification of attack vectors 1108. This step provides a detailed breakdown of the potential threats detected, allowing for a more granular understanding and response to the identified risks.

FIG. 12 is a flow diagram of an example method 1200 for evaluating entities communicating over a network. The steps shown in FIG. 12 may be performed by any suitable computer-executable code and/or computing system, including example system 100 in FIG. 1, example system 200 in FIG. 2, example system 300 in FIG. 3, example system 5 in FIG. 5, and/or variations or combinations of one or more of the same. In one example, each of the steps shown in FIG. 12 may represent an algorithm whose structure includes and/or is represented by multiple sub-steps.

As illustrated in FIG. 12, at step 1210, one or more of the systems described herein may receive a set of network traffic data and a potential bot candidate associated with the set of network traffic data. For example, receiving module 204 may, as part of computing device 302 in FIG. 3, cause computing device 302 to receive network traffic data 242 and potential bot candidate 304 associated with the set of network traffic data. Receiving module 204 may receive network traffic data 242 and potential bot candidate 304 in any of the ways disclosed herein.

At step 1220, one or more of the systems described herein may adjust a bot risk assessment associated with the potential bot candidate by analyzing a subset of the set of network traffic data corresponding to the potential bot candidate via an expert machine learning model trained to detect attack vectors based on network traffic data associated with potential bot candidates. For example, adjusting module 206 may, as part of computing device 302 in FIG. 3, cause computing device 302 to adjust bot assessment 308 by analyzing candidate traffic data 306 via expert machine learning model 244.

In some embodiments, as described in greater detail above, the heavyweight expert machine learning model may include a self-supervised generative machine learning model. In additional embodiments, the self-supervised generative machine learning model may use a session included in the set of network traffic data as a context window for predicting attack vectors. In further embodiments, the self-supervised generative machine learning model may use masked tokens generated from the set of network traffic data to predict attack vectors. Adjusting module 206 may adjust bot assessment 308 and/or analyze the subset of network traffic data 242 via expert machine learning model 244 in any of the ways disclosed herein.

At step 1230, one or more of the systems disclosed herein may output the bot risk assessment associated with the potential bot candidate. For example, outputting module 208 may, as part of computing device 302 in FIG. 3, cause computing device 302 to output bot assessment 308. Outputting module 208 may output bot assessment 308 in any of the ways disclosed herein.

Furthermore, although not shown in FIG. 12, in some examples, one or more of the systems disclosed herein may discover, by processing the set of network traffic data via a discoverer machine learning model trained to discover potential bot candidates from aggregate network traffic data, the potential bot candidate. For example, one or more of modules 202 (e.g., one or more of receiving module 204, adjusting module 206, and/or outputting module 208) may, as part of computing device 302 in FIG. 2, cause computing device 302 to discover, by processing network traffic data 242 via discoverer machine learning model 246, potential bot candidate 304.

One or more of modules 202 may discover, by processing network traffic data 242 via discoverer machine learning model 246, potential bot candidate 304 in any of the ways disclosed herein. For example, as described above in reference to FIG. 2 through FIG. 11, one or more of modules 202 may identify an entity that has transmitted message information included in the set of network traffic data, generate signature information associated with the entity based at least in part on the message information included in the set of network traffic data associated with the entity, and may designate, based at least on the signature information and the message information included in the set of network traffic data associated with the entity, the entity as the potential bot candidate. In some embodiments, the set of network traffic data may include at least one of (1) data traffic between at least one source entity and at least one target entity, (2) a volume of the data traffic between at least one source entity and at least one target entity, (3) a set of unique URLs traversed by an entity, or geographic location information associated with at least one host.

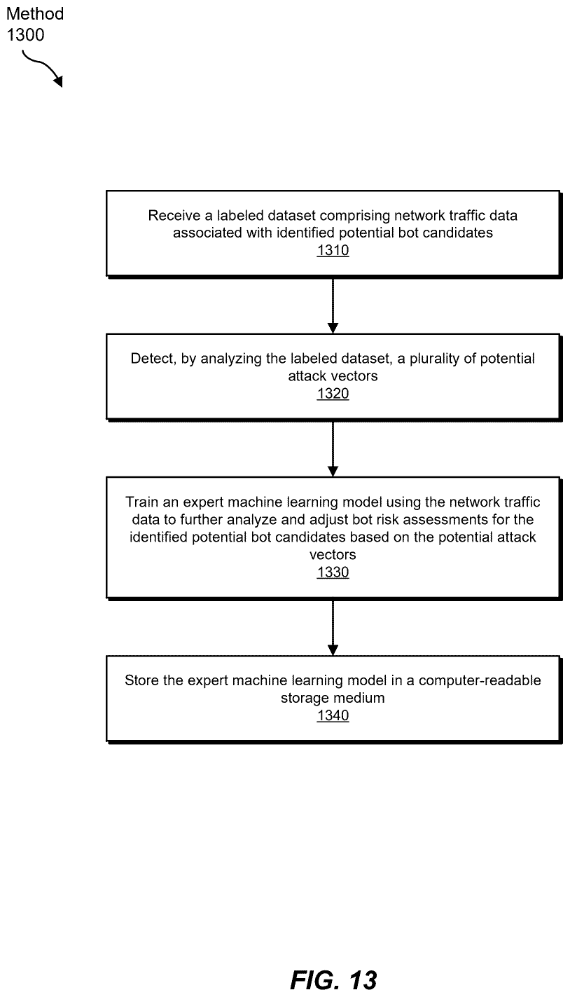

FIG. 13 is a flow diagram of an example method 1300 for training an expert machine learning model in accordance with some embodiments disclosed herein. The steps shown in FIG. 13 may be performed by any suitable computer-executable code and/or computing system, including example system 100 in FIG. 1, example system 200 in FIG. 2, example system 300 in FIG. 3, example system 5 in FIG. 5, and/or variations or combinations of one or more of the same. In one example, each of the steps shown in FIG. 13 may represent an algorithm whose structure includes and/or is represented by multiple sub-steps.

As shown in FIG. 13, at step 1310, one or more of the systems described herein may receive a labeled dataset comprising network traffic data associated with identified potential bot candidates. One or more of the systems described herein may accomplish this operation in any of the ways disclosed herein.

At step 1320, one or more of the systems described herein may detect, by analyzing the labeled dataset, a plurality of potential attack vectors. This operation may be accomplished in in any of the ways disclosed herein.

At step 1330, one or more of the systems described herein may train an expert machine learning model using the network traffic data to further analyze and adjust bot risk assessments for the identified potential bot candidates based on the potential attack vectors. This operation may be accomplished in in any of the ways disclosed herein.

At step 1340, one or more of the systems disclosed herein may store the heavyweight expert machine learning model in a computer-readable storage medium. This operation may be accomplished in in any of the ways disclosed herein.

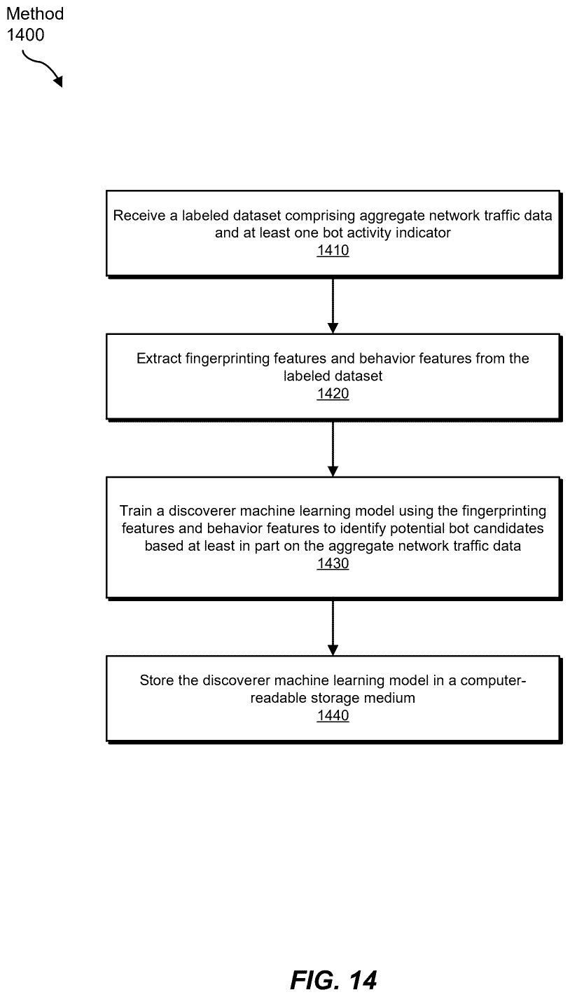

FIG. 14 is a flow diagram of an example method 1400 for training a discoverer machine learning model in accordance with some embodiments disclosed herein. The steps shown in FIG. 14 may be performed by any suitable computer-executable code and/or computing system, including example system 100 in FIG. 1, example system 200 in FIG. 2, example system 300 in FIG. 3, example system 5 in FIG. 5, and/or variations or combinations of one or more of the same. In one example, each of the steps shown in FIG. 14 may represent an algorithm whose structure includes and/or is represented by multiple sub-steps.

As shown in FIG. 14, at step 1410, one or more of the systems described herein may receive a labeled dataset comprising aggregate network traffic data and at least one bot activity indicator. This operation may be accomplished in in any of the ways disclosed herein.

At step 1420, one or more of the systems described herein may extract fingerprinting features and behavior features from the labeled dataset. This operation may be accomplished in in any of the ways disclosed herein.

At step 1430, one or more of the systems described herein may train a discoverer machine learning model using the fingerprinting features and behavior features to identify potential bot candidates based at least in part on the aggregate network traffic data. This operation may be accomplished in in any of the ways disclosed herein.

At step 1440, one or more of the systems described herein may store the discoverer machine learning model in a computer-readable storage medium. This operation may be accomplished in in any of the ways disclosed herein.

As may be clear from the foregoing description, some embodiments of the techniques presented herein may provide an advanced system designed to detect and categorize potential cyber threats, with a focus on bot activities and attack vectors. Some embodiments of this disclosure may employ a combination of machine learning models to analyze vast amounts of network traffic data and identify suspicious activities.

As described above, some embodiments may operate in two distinct stages. An initial stage may use lightweight models such as XGBoost and volumetric anomaly detectors to filter potential threats from network traffic. This may act as a foundational filter, preparing data for a more in-depth analysis in the next phase.

In the second stage, embodiments may employ GPT-based NLP models and embedding-based vector searches. These models are refined using both labeled data from web application firewalls and unlabeled access logs, enhancing their ability to detect a broad spectrum of attack vectors. The session-based approach, treating continuous activities as coherent units, further refines the system's threat prediction capabilities.

Some embodiments of the techniques disclosed herein may integrate diverse data sources, from WAF logs to IP domain logs, and process them for feature extraction. This may ensure a comprehensive data set for the models to learn from. By merging traditional data analysis with modern machine learning techniques, embodiments of the systems and methods disclosed herein may offer a competitive and adaptable solution for cyber threat detection.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. For example, one or more of the modules recited herein may receive network traffic data to be transformed, transform the network traffic data, output a result of the transformation to evaluate one or more entities communicating over a network, use the result of the transformation to train one or more machine learning models, and store the result of the transformation to make predictions using the trained machine learning model. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

The term “computer-readable medium,” as used herein, generally refers to any form of device or medium capable of storing or carrying computer-readable instructions. Examples of computer-readable media include non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the instant disclosure. The embodiments disclosed herein should be considered in all respects illustrative and not restrictive. Reference should be made to the appended claims and their equivalents in determining the scope of the instant disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A method comprising:
receiving a set of network traffic data and data representative of a potential bot candidate associated with the set of network traffic data;
adjusting a bot risk assessment associated with the potential bot candidate by analyzing a subset of the set of network traffic data corresponding to the potential bot candidate via an expert machine learning model trained to detect attack vectors based on network traffic data associated with potential bot candidates; and
outputting the bot risk assessment associated with the potential bot candidate.

2. The method of claim 1, wherein the expert machine learning model comprises a self-supervised generative machine learning model.

3. The method of claim 2, wherein the self-supervised generative machine learning model uses a session included in the set of network traffic data as a context window for predicting attack vectors.

4. The method of claim 2, wherein the self-supervised generative machine learning model uses masked tokens generated from the set of network traffic data to predict attack vectors.

5. The method of claim 1, further comprising discovering, by processing the set of network traffic data via a discoverer machine learning model trained to discover potential bot candidates from aggregate network traffic data, the potential bot candidate.

6. The method of claim 5, further comprising training the discoverer machine learning model by:
receiving a labeled dataset comprising aggregate network traffic data and at least one bot activity indicator;
extracting fingerprinting features and behavior features from the labeled dataset;
training a discoverer machine learning model using the fingerprinting features and behavior features to identify potential bot candidates based at least in part on the aggregate network traffic data; and
storing the discoverer machine learning model in a computer-readable storage medium.

7. The method of claim 5, further comprising adjusting the discoverer machine learning model based on an output from the expert machine learning model.

8. The method of claim 5, a parameter amount of the discoverer machine learning model comprising an amount value fewer than a parameter amount of the expert machine learning model.

9. The method of claim 8, wherein the parameter amount of the discoverer machine learning model is within a lightweight model parameter amount threshold.

10. The method of claim 9, wherein the lightweight model parameter amount threshold comprises at least one of:
up to 1,000,000 parameters; or
between 1,000,000 parameters and 1,000,000,000 parameters.

11. The method of claim 8, wherein the parameter amount of the expert machine learning model exceeds a heavyweight model parameter amount threshold.

12. The method of claim 11, wherein the heavyweight model parameter amount threshold comprises at least 1,000,000,000 parameters.

13. The method of claim 5, wherein a computing resource requirement of the expert machine learning model exceeds a threshold computing resource requirement.

14. The method of claim 13, wherein a computing resource requirement of the discoverer machine learning model is within the threshold computing resource requirement.

15. The method of claim 5, wherein discovering the potential bot candidate comprises:
identifying an entity that has transmitted message information included in the set of network traffic data;
generating signature information associated with the entity based at least in part on the message information included in the set of network traffic data associated with the entity; and
designating, based at least on the signature information and the message information included in the set of network traffic data associated with the entity, the entity as the potential bot candidate.

16. The method of claim 6, wherein the set of network traffic data comprises at least one of:
data traffic between at least one source entity and at least one target entity;
a volume of the data traffic between at least one source entity and at least one target entity;
a set of unique URLs traversed by an entity; or
geographic location information associated with at least one host.

17. The method of claim 1, further comprising training the expert machine learning model by:
receiving a labeled dataset comprising network traffic data associated with identified potential bot candidates;
detecting, by analyzing the labeled dataset, a plurality of potential attack vectors;
training a expert machine learning model using the network traffic data to further analyze and adjust bot risk assessments for the identified potential bot candidates based on the plurality of potential attack vectors; and
storing the expert machine learning model in a computer-readable storage medium.

18. A system comprising:
at least one processor; and
at least one storage medium having encoded thereon executable instructions that, when executed by the at least one processor, cause the at least one processor to carry out a method comprising:
receiving a set of network traffic data and data representative of a potential bot candidate associated with the set of network traffic data;
adjusting a bot risk assessment associated with the potential bot candidate by analyzing a subset of the set of network traffic data corresponding to the potential bot candidate via an expert machine learning model trained to detect attack vectors based on network traffic data associated with potential bot candidates; and
outputting the bot risk assessment associated with the potential bot candidate.

19. The system of claim 18, the method further comprising discovering, by processing the set of network traffic data via a discoverer machine learning model trained to discover potential bot candidates from aggregate network traffic data, the potential bot candidate.

20. At least one computer-readable storage medium having encoded thereon executable instructions that, when executed by at least one processor, cause the at least one processor to carry out a method comprising:
receiving a set of network traffic data and data representative of a potential bot candidate associated with the set of network traffic data;
adjusting a bot risk assessment associated with the potential bot candidate by analyzing a subset of the set of network traffic data corresponding to the potential bot candidate via an expert machine learning model trained to detect attack vectors based on network traffic data associated with potential bot candidates; and
outputting the bot risk assessment associated with the potential bot candidate.
